(19) United States
(12) Patent Application Publication
(10) Pub. No.: US 2009/0185694 A1
(43) Pub. Date: Jul. 23, 2009

(54) LOUDSPEAKER INTERCONNECT TERMINAL

(76) Inventors: Yoichiro Sumitani, Rancho Palos Verdes, CA (US); Chun-Yi Lin, Xinzhuang City (TW); Chih-Huang Hsiao, Sansia Township (TW)

Correspondence Address: STETINA BRUNDA GARRED & BRUCKER, 75 ENTERPRISE, SUITE 250, ALISO VIEJO, CA, 92656, US

(21) Appl. No.: 12/017,313

(22) Filed: Jan. 21, 2008

(51) Int. Cl. H04R 5/00

(52) U.S. Cl. 381/17

(57) ABSTRACT

A loudspeaker interconnect terminal for selectively coupling a plurality of loudspeaker drivers to a monophonic source and a stereophonic source. The terminal includes a body defined by a first side and a second side, and first and second sets of input terminals disposed on a respective one of the first and second sides. The terminal also includes an electrical switch with an actuator having a first position and a second position. The first set of input terminals are connected to the corresponding one of the second set of input terminals and a switch cover coupled to the actuator conceals at least a part of the first set of input terminals with the actuator in the first position.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention generally relates to terminals for interconnecting electrical components. More particularly, the present invention relates to interconnect terminals for selectively coupling monaural and stereophonic sources to loudspeakers.

2. Related Art

Loudspeaker drivers are conventionally utilized to reproduce sound. Electrical signals representative of a sound wave are generated by a signal source, amplified, and applied to a voice coil. The induced magnetic field between the voice coil and a permanent magnet effects a mechanical movement of the voice coil. The change in air pressure generated by a diaphragm affixed to the moving voice coil results in sound corresponding to the electrical signal.

In earlier audio systems, sound was recorded and played back on a single channel, otherwise known as monaural/monophonic or simply “mono.” A single microphone was typically used to make mono recordings, though signals from multiple microphones could be fed into a common signal path. Similarly, the playback of mono recordings required only a single loudspeaker driver, but multiple loudspeaker drivers could be interconnected to a source over a common signal path. Entirely mono systems have largely been supplanted by stereophonic or “stereo” systems, where at least two channels are utilized to represent and reproduce sound. These two channels are typically representative of left and right sides of the sound field, whereas the single channel of mono is the representative of the center of the sound field. Stereo systems are intended to create a more natural sound heard from different directions, though some artists may desire to create a “feel” particular to mono recording in their work. Playback of stereo recordings requires two or more loudspeaker drivers, and sophisticated systems may utilize more than one loudspeaker driver for each channel.

Generally, the drivers are mounted in an enclosure as a standalone unit. One common loudspeaker system is that which utilizes variously configured drivers that collectively reproduce high frequency components, middle frequency components, and low frequency components of the sound signal. This loudspeaker system typically includes a single set of input terminals, a positive and a negative, with crossover circuitry segregating the input signal into the high, middle, and low frequency components and directing the same to the tweeter, the mid-range, and the subwoofer, respectively.

Another common loudspeaker system is that which includes one or more pairs of drivers mounted symmetrically in relation to the enclosure, sometimes referred to as dual driver systems. In one configuration, each driver corresponds to a single channel and requires an independent set of input terminals that are connectible to the signal source. The driver mounted on the left side of the enclosure corresponds to the left channel, and the driver mounted on the right side of the enclosure corresponds to the right channel. From the single, standalone loudspeaker system, a stereo sound is reproduced. This configuration is appropriate where the one loudspeaker system is the only one being utilized in an environment, or as a center channel in a surround sound configuration.

Where multiple loudspeaker system installations are contemplated, however, an alternative configuration may be more appropriate. For example, one dual driver system may be mounted in the left side of a room, and another dual driver system may be mounted in the right side of the room. Driving each dual driver system from a stereo source may not result in the desired stereo effects and instead result in unnatural sound reproduction. Instead, each dual driver system may be configured for a single channel, in which both of the drivers in each dual driver system are connected a common signal source. One set of input terminals may interconnect both drivers, or where each driver is provided with a separate set of input terminals, two pairs of cabling may be used to connect the single input channel to the two drivers. In the alternative, a jumper cable may be used to connect one set of input terminals to the other set of input terminals.

Accordingly, there is a need in the art for an improved loudspeaker interconnect terminal that can be readily switched between interfacing with mono and stereo sources.

### BRIEF SUMMARY

In accordance with one embodiment of the present invention, there is provided a loudspeaker interconnect terminal for selectively coupling a plurality of loudspeaker drivers to a monophonic source and a stereophonic source. The interconnect terminal may include a terminal body defined by a first side and an opposed second side. Additionally, the interconnect terminal may include first and second sets of input terminals disposed on a respective one of the first and second sides of the terminal body. There may also be provided an electrical switch including an actuator having a first position and a second position. The first set of input terminals may be connected to the corresponding one of the second set of input terminals where the actuator is in the first position. The first set of input terminals may be disconnected from the corresponding one of the second set of input terminals with the actuator in the second position. The interconnect terminal may also include a switch cover that is coupled to the actuator. The switch cover may conceal at least a part of the first set of input terminals when the actuator is in the first position. Thus, access to the first set of input terminals is restricted. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a rear perspective view of a dual driver loudspeaker system including a loudspeaker interconnect terminal in accordance with one embodiment of the present invention;

FIG. 2 is a top plan view of the dual driver loudspeaker system showing a pair of woofers and a pair of tweeters mounted in a coaxial relation thereto.

FIG. 3 is an exploded perspective view of the loudspeaker interconnect terminal including a housing, a circuit board, input terminals, and a sliding switch;

FIG. 4 is a top plan view of the loudspeaker interconnect terminal with the sliding switch in the stereo position;

FIG. 5 is a top plan view of the loudspeaker interconnect terminal with the sliding switch in the mono position and blocking access to one set of the input terminals;

FIG. 6 is a diagram of the circuit board in one embodiment of the present invention; and

FIG. 7 is a top plan view of the circuit board illustrating circuit regions with crossover circuit and protection components superimposed thereon.

### DETAILED DESCRIPTION

The detailed description set forth below in connection with the appended drawings is intended as a description of the presently preferred embodiment of the invention, and is not intended to represent the only form in which the present invention may be constructed or utilized. It is understood that the use of relational terms such as first and second, top and bottom, and the like are used solely to distinguish one from another entity without necessarily requiring or implying any such actual relationship or order between such entities.

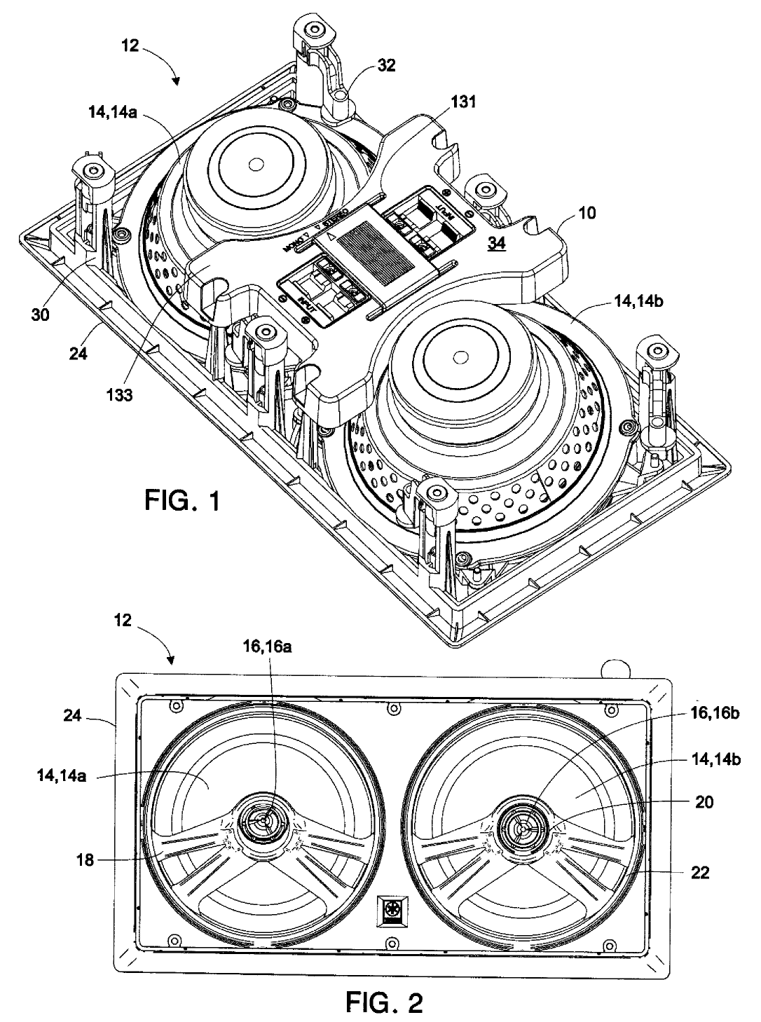

With reference to FIGS. 1, and 2 a loudspeaker interconnect terminal 10 in accordance with one embodiment of the present invention is shown attached to an exemplary loudspeaker system 12. The loudspeaker system 12 includes left and right woofers 14a, 14b, which accurately reproduce lower frequency sound (bass). Additionally, the loudspeaker system 12 includes left and right tweeters 16a, 16b, which accurately reproduce higher frequency sound (treble). Left and right woofers 14a, 14b will be collectively referenced herein as woofers 14, and left and right tweeters 16a, 16b will be collectively referenced herein as tweeters 16. As shown in FIG. 2, the tweeters 16 are mounted to the woofer 14 in a coaxial relation thereto. In further detail, a grille 18 with a central tweeter housing 20 is mounted to the woofer 14. It will be appreciated that there are numerous possible variations with respect to the configuration of the grille 18. In the exemplary configuration shown in FIG. 2, the grille 18 includes radial spokes that are attached to the rim of the woofer 14. The woofers 14, in turn, are conventionally mounted to a baffle 24. A front face 26 of the baffle 24 may be variously finished to match the motif of the grille 18, the woofers 14, and the tweeters 16.

The loudspeaker system 12 may be a standalone unit, in which case, the baffle 24 is a part of an enclosure that houses the above-described components. Alternatively, it is also contemplated that the loudspeaker system 12 be permanently mounted to an architectural structure. In this regard, as shown in FIG. 1, a rear face 28 of the baffle 24 includes one or more mounting posts 30 extending therefrom. A clamp member 32, which is slidably coupled to the mounting post 30, engages the architectural structure. It is understood that other modalities by which the loudspeaker system 12 is mounted to a wall or other like architectural speaker are known in the art, and the above is presented by way of example only. Along these lines, it will be readily appreciated by those having ordinary skill in the art that the aforementioned configuration of the loudspeaker system 12 is presented by way of example and not of limitation. Other configurations of the loudspeaker system 12 may be readily substituted without departing from the scope of the present invention.

The loudspeaker interconnect terminal 10 selectively couples the speaker drivers of the loudspeaker system 12, including the woofers 14 and the tweeters 16, to a monophonic source and a stereophonic source. As indicated above, a stereophonic or stereo source is that which provides two or more signal channels, while a monophonic or mono source is that which provides one signal channel. In the context of the exemplary loudspeaker system 12, when connected to a stereo source, the left woofer 14a and tweeter 16a are driven by a first channel, and the right woofer 14b and tweeter 16b are driven by a second channel. On the other hand, when the loudspeaker system 12 is connected to a mono source, all of the woofers 14 and the tweeters 16 are driven by a single channel.

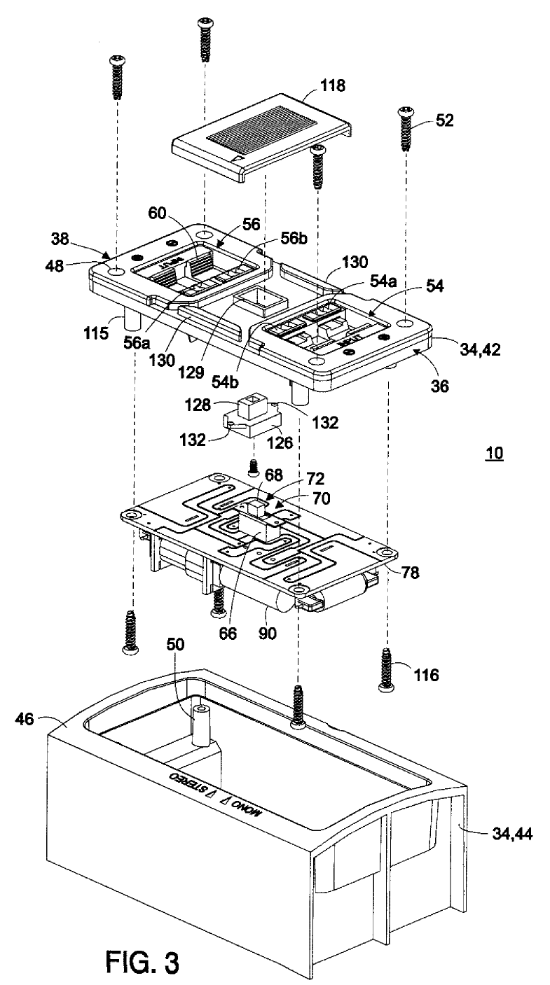

With reference to FIG. 3, another embodiment of the loudspeaker interconnect terminal 10 is illustrated, and includes a terminal body 34. The embodiment of the loudspeaker interconnect terminal 10 illustrated in FIG. 1 has minor configuration differences with respect to the terminal body 34, the details of which will be explained further below. However, it will be appreciated by those having ordinary skill in the art that the embodiments illustrated in FIGS. 1 and 3 share substantial similarities.

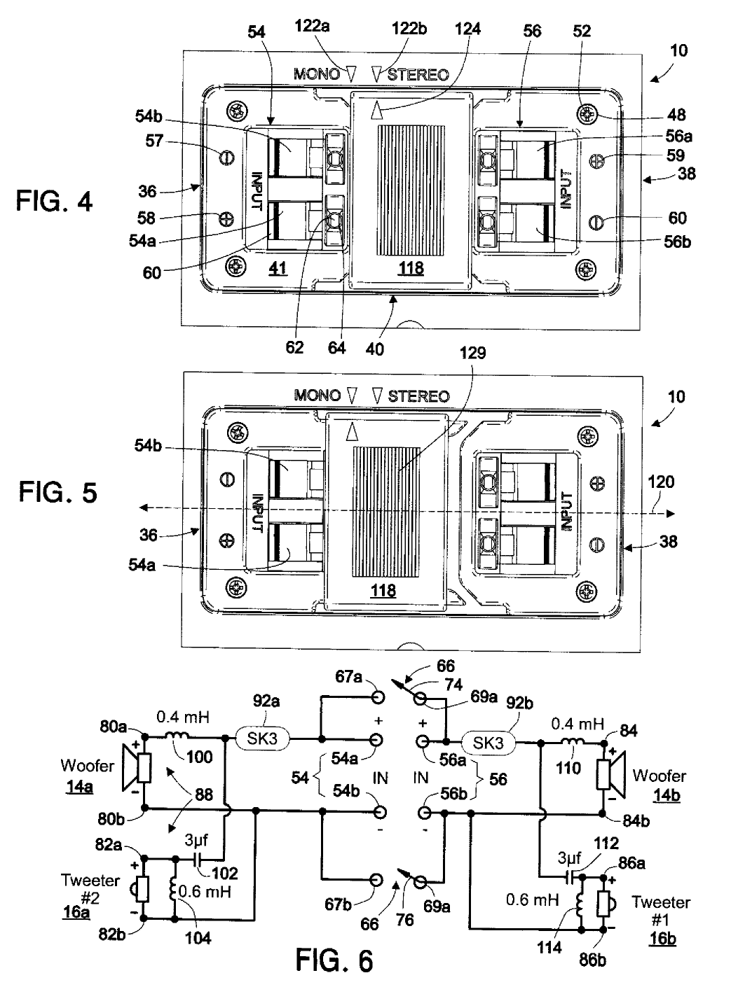

As shown in FIGS. 3 and 4, the terminal body 34 is rectangular, and is generally defined by a first side 36, an opposed second side 38, and a central portion 40. Additionally, the terminal body 34 defines a top surface 41. In further detail, the terminal body 34 is defined by an upper shell 42 that mates with a lower shell 44. The lower shell 44 defines an opening 46 through which the upper shell 42 is inserted for mating therewith. Each corner of the upper shell 42 defines a mounting hole 48 that is aligned with a corresponding mounting post 50 on the lower shell 44. In order to secure the engagement of the lower shell 44 to the upper shell 42, a screw 52 is inserted through the mounting hole 48 and threadably engaged to the mounting post 50.

A first set of input terminals 54 are disposed on the first side 36 of the terminal body 34, while a second set of input terminals 56 are disposed on the second side 38 of the same. The first set of input terminals 54 includes a first positive input terminal 54a and a first negative input terminal 54b. The second set of input terminals 56 includes a second positive input terminal 56a and a second negative input terminal 56b. It is understood that the positive and negative input terminals correspond to the positive and negative lines from the audio signal source. As illustrated in FIG. 4, the first and second positive input terminals 54a and 56a are denoted as such with the “+” markings 58, and the first and second negative input terminals 54b and 56b are denoted as such with the “−” markings 59. The markings 58 and 59 are understood to be etchings made on the top surface 41 and positioned between input terminals 54, 56 and the edge of the terminal body 34, though any other suitable location may be selected. In addition to the markings 58, 59, the proper polarity of the positive and negative input terminals 54, 56 may be indicated with coloring applied thereto; conventionally, the color red indicates positive polarity and the color black indicates negative polarity.

In accordance with one embodiment of the present invention, the input terminals 54, 56 is of a biased lever type including a lever element 60 that may be variously manipulated to release a clamp element 62 from blocking an access slot 64. It is understood that a wire carrying the electrical current from the signal source is inserted through the access slot 64 and locked into place with the release of the clamp element 62 on to the wire. Other embodiments contemplate the substitution of binding post type terminals, and as will be recognized by one of ordinary skill in the art, any other appropriate terminal type may be readily substituted. Regardless of the type of input terminals utilized, it is envisioned that the input terminals 54, 56 are mounted to the upper shell 42 in a recessed relation to the top surface 41, the purpose of which will become more apparent below.

As best shown in FIGS. 3 and 6, the loudspeaker interconnect terminal 10 includes an electrical switch 66 with an actuator 68 having a first position 70 and a second position 72. More particularly, the switch 66 is a double-pole single-throw type switch including a positive switch contact 74 and a negative switch contact 76. It will be understood, however, that alternative switch configurations may be substituted, for example, a pair of single-pole single-throw switches that can be mechanically linked together. With the actuator 68 in the first position 70, the first set of input terminals 54 are electrically connected to the respective one of the second set of input terminals 56. In other words, the first positive input terminal 54a is shorted to the second positive input terminal 56a via the positive switch contact 74, and the first negative input terminal 54b is shorted to the second negative input terminal 56b via the negative switch contact 76 when the actuator 68 is in the first position 70. With the actuator 68 in the second position 72, the first set of input terminals 54 are disconnected or isolated from the corresponding ones of the second set of input terminals 56. This is the state of the switch 66 as shown in FIG. 6. The first positive input terminal 54a is isolated from the second positive input terminal 56a, and the first negative input terminal 54b is isolated from the second negative input terminal 56b.

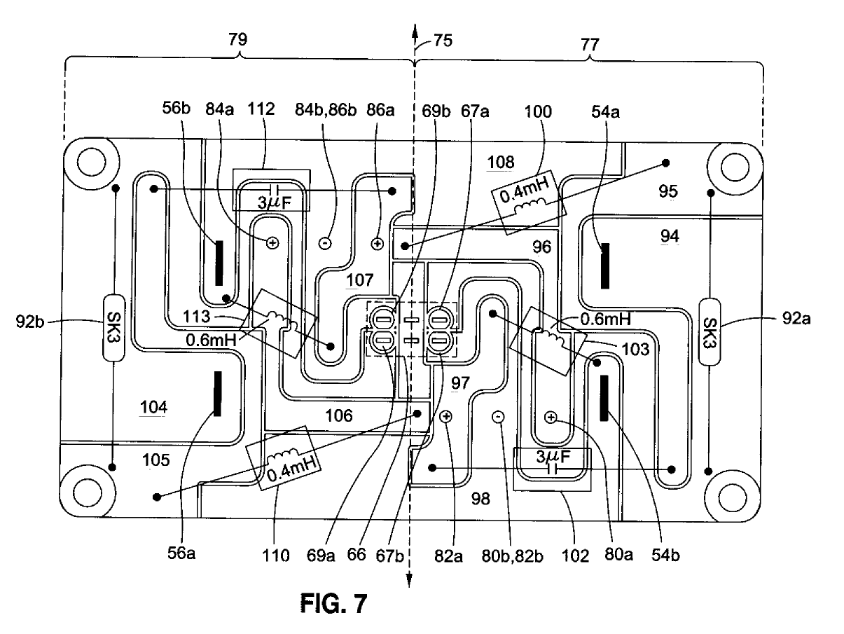

With reference to FIG. 3, the switch 66 is mounted to a circuit board 78, as are the input terminals 54, 56. Along these lines, the circuit shown in the schematic diagram of FIG. 6 is embodied in the circuit board 78 shown in FIG. 3 and as further illustrated in FIG. 7. As indicated above, the loudspeaker interconnect terminal 10 connects the various drivers of the loudspeaker system 12 including the woofers 14 and the tweeters 16. According to one embodiment of the present invention, the first set of input terminals 54 are electrically connectible to at least a first one of a plurality of loudspeaker drivers 14, 16, and the second set of input terminals 56 are electrically connectible to at least a second one of a plurality of the same. The circuit, and thus the circuit board 78, includes positive and negative left woofer terminals 80a,b that are connectible to the left woofer 14a, as well as positive and negative left tweeter terminals 82a,b connectible to the left tweeter 16a. Similarly, the circuit and the circuit board 78 correspondingly include positive and negative right woofer terminals 84a,b connectible to the right woofer 14b, and positive and negative right tweeter terminals 86a,b connectible to the right tweeter 16b.

According to one embodiment, the woofers 14 and the tweeters 16 are connected in a parallel network, with the high frequency components and the low frequency components of the audio signal being segregated by crossover circuits 88 comprised of circuit components 90. Additionally, in order to prevent overloading the loudspeaker drivers 14, 16, the circuit includes protective elements 92a,b, respectively, connected in series therewith. According to one embodiment, the protective element 92 is a conventional incandescent lamp that increases in resistance to prevent overloading. It is understood that the combined impedance is decreased where the one of the woofers 14 and the one of the tweeters 16 are connected in parallel. The total impedance is further decreased when both the left and right woofers 14a,b and the left and right woofers 16a,b are connected in parallel, that is, when all of the loudspeaker drivers 14,16 are connected in a parallel relation to the source. In this regard, the protective elements 92a,b are understood to limit increased current to the loudspeaker drivers 14, 16 that results from such decreased impedance seen by a mono source. It will be appreciated that the crossover circuits 88 and the protective elements 92 have been provided by way of example only and not of limitation, and any other suitable crossover circuitry, whether active or passive, and any other suitable protection component, may be readily substituted without departing from the scope of the present invention.

Referring now to FIGS. 6 and 7, the circuit board 78 is defined by a plurality of connected circuit regions with the circuit components 90 connected thereto. The first positive input terminal 54a is electrically connected to a first circuit region 94. The first circuit region 94 is also connected to a first positive pole 67a of the switch 66, and is linked to a second circuit region 95 over the protective element 92a. Connecting the second circuit region 95 to a third circuit region 96 is a first inductor 100 having a nominal value of 0.4 mH. The third circuit region 96 also includes the positive left woofer terminal 80a. Furthermore, a first capacitor 102 having a nominal value of 3 μf connects the second circuit region 95 to a fourth circuit region 97. A second inductor 103 having a nominal value of 0.6 mH is placed between the fourth circuit region 97 and a fifth circuit region 98, which also includes the negative left woofer terminal 80b, the negative left tweeter terminal 82b, the first negative input terminal 54b, and a first negative pole 67b of the switch 66. The fourth circuit region 97 includes the positive left tweeter terminal 82a.

It is contemplated that the circuit board 78 is divided into a first (right) side 77 and a second (left) side 79 at a center line 75 like the terminal body 34. According to one embodiment of the present invention, the first (right) side 77 described above is essentially a laterally inverted mirror image of the second (left) side 79. In further detail, the second positive input terminal 56a is electrically connected to a sixth circuit region 104. The sixth circuit region 104 is connected to a second positive pole 69a of the switch 66, and is also linked to a seventh circuit region 105 via the protective element 92b. The seventh circuit region 105 is connected to an eighth circuit region 106 with a third inductor 110 having a nominal value of 0.4 mH. The eighth circuit region 106 also includes the positive right woofer terminal 84a. A second capacitor 112 having a nominal value of 3 pf connects the seventh circuit region 105 to a ninth circuit region 107. A fourth inductor 113 having a nominal value of 0.6 mH is placed between the ninth circuit region 107 and a tenth circuit region 108, which also includes the negative right woofer terminal 84b, the negative right tweeter terminal 86b, the second negative input terminal 56b, and a second negative pole 69b of the switch 66. The ninth circuit region 107 includes the positive right tweeter terminal 86a.

Referring back to FIG. 3, the circuit board 78 is mounted to the upper shell 42. The corners of the circuit board 78 define mounting holes 114, and the corresponding locations on the upper shell 42 define mounting posts 115. Screws 116 are inserted through the mounting holes 114, and the heads of the screws 116 frictionally retains the circuit board 78 to the mounting posts 115.

The loudspeaker interconnect terminal 10 further includes a switch cover 118 coupled to the actuator 68. Generally, as best shown in FIG. 5, the switch cover 118 conceals at least a part of the first set of input terminals 54 with the actuator 68 in the first position 70. Thus, access to the first set of input terminals 54 and specifically the access slot 64 is restricted. As explained above, the first and second sets of input terminals 54, 56 are mounted in a recessed relation to the top surface 41 so that the switch cover 118 slides over the same without being obstructed. It is understood that all of the drivers in the loudspeaker system 12 may be driven by a single “mono” channel by shorting the first set of input terminals 54 to corresponding ones of the second set of input terminals 56. By preventing access to the first set of input terminals while in this state, a second channel of a stereo source cannot be connected, and the likelihood of accidentally damaging the source and/or the loudspeakers is greatly reduced. The second set of input terminals 56 remains accessible while the first set of input terminals 54 is not. As best shown in FIG. 6, with the actuator 68 in the second position 72, the switch cover 118 does not conceal either of the first or second sets of input terminals 54, 56, permitting access to both. In this state, the right side 77 and the left side 79 of the circuit board 78 are electrically isolated from each other, and can accept two channel inputs from a stereo source with the right woofer 14a and the right tweeter 16a being driven independently of the left woofer 14b and the left tweeter 16b.

With reference to FIGS. 3 and 7, the switch 66 is centrally disposed, or otherwise disposed in a region in the vicinity of the center line 75 of the circuit board 78 between the first and second sets of input terminals 54, 56. As shown in FIGS. 4 and 5, the switch cover 118 and the actuator 68 of the switch 66 has a range of motion along a lateral axis 120 that extends between the first side 36 and the second side 38 of the terminal body 34. It is contemplated that the switch 66 is positioned relative to the terminal body 34 such that with the actuator 68 in the second position 72, the switch cover 118 is centered between the first and second sets of input terminals 54, 56. Along these lines, it is also contemplated that the range of motion of the actuator 68, and thus the switch cover 118, is limited to the extent of the second set of input terminals 56. In other words, the switch cover 118 extends to the right no further than the innermost part of the second set of input terminals 56. So that the position of the actuator 68 is readily ascertainable, the top surface 40 of the terminal body 34 includes an inscription “Mono” and “Stereo” with corresponding tick marks 122a,b, respectively. The switch cover 118 also includes a tick mark 124 that is aligned with either the mono tick mark 122a or the stereo tick mark 122b depending on whether the actuator 68 is in the first position 70 or the second position 72. In this regard, the range of motion of the switch cover 118 is also contemplated as being between the mono tick mark 122a and the stereo tick mark 122b.

As described above, one embodiment contemplates the switch cover 118 as having only two states or positions: with the tick mark 124 aligned with the mono tick mark 122a, or with the tick mark 124 aligned with the stereo tick mark 122b. To prevent the switch cover 118 and the actuator 68 from entering an intermediate, indeterminate state, a coupling 126 links the two. Specifically, the coupling 126 is fixed to the actuator 68, and a head portion 128 of the coupling 126 extends through an aperture 129 defined by the upper shell 42 and is fixed to the switch cover 118. Tabs 132 of the coupling are cooperatively engaged to protrusions on the rear surface of the upper shell 42, and a substantial amount of force is necessary to overcome the frictional retention between such protrusions and the tabs 132. This additionally provides auditory and haptic feedback while switching from one state or position to another with a noticeable “click.” Along these lines, the top surface of the switch cover 118 defines corrugations 131 for increased friction during use.

In order to properly guide the switch cover 118 along its predefined range of movement, the upper shell 42 includes a pair of opposed tracks 130 along which it is slidably engaged. The tracks 130 in the embodiment shown in FIGS. 3, 4, and 5 are defined by the upper shell 42, while in the embodiment shown in FIG. 1, tracks 131 are defined by a separate enclosure 133. It is understood, however, that the functionality of such embodiment is consistent with the embodiments described above.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. A loudspeaker interconnect terminal for selectively coupling a plurality of loudspeaker drivers to a monophonic source and a stereophonic source, the interconnect terminal comprising:
a terminal body defined by a first side and an opposed second side;
first and second sets of input terminals disposed on a respective one of the first and second sides of the terminal body;
an electrical switch including an actuator having a first position and a second position, the first set of input terminals being connected to the corresponding one of the second set of input terminals with the actuator in the first position, and the first set of input terminals being disconnected from the corresponding one of the second set of input terminals with the actuator in the second position; and
a switch cover coupled to the actuator, the switch cover concealing at least a part of the first set of input terminals with the actuator in the first position, thereby restricting access to the first set of input terminals.

2. The loudspeaker interconnect terminal of claim 1, wherein:
the electrical switch is centrally disposed in relation to the terminal body between the first and second sets of input terminals; and
the switch cover has a range of motion along a lateral axis of the terminal body extending between the first and second sides.

3. The loudspeaker interconnect terminal of claim 2, wherein the range of motion of the actuator and the switch cover is limited to the extent of the second set of input terminals.

4. The loudspeaker interconnect terminal of claim 2, wherein the terminal body defines a pair of opposed tracks, along which the switch cover is slidably engaged.

5. The loudspeaker interconnect terminal of claim 1, wherein the switch cover reveals the first set of input terminals with the actuator in the second position, thereby allowing access to the first set of input terminals.

6. The loudspeaker interconnect terminal of claim 1, wherein the terminal body is defined by a top surface, the first and second sets of input terminals being mounted in a recessed relation thereto.

7. The loudspeaker interconnect terminal of claim 1, wherein:
the first set of input terminals are electrically connectible to at least a first one of the plurality of loudspeaker drivers; and
the second set of input terminals are electrically connectible to at least a second one of the plurality of loudspeaker drivers different from the first one of the plurality of loudspeakers.

8. The loudspeaker interconnect terminal of claim 1, wherein the first and second sets of input terminals each include a positive input terminal and a negative input terminal.

9. The loudspeaker interconnect terminal of claim 8, wherein the electrical switch is a double pole single throw type including a positive switch contact and a negative switch contact.

10. The loudspeaker interconnect terminal of claim 9, wherein the first positive input terminal is shorted to the second positive input terminal via the positive switch contact, and the first negative input terminal is shorted to the second negative input terminal via the negative switch contact with the actuator being in the first position.

11. The loudspeaker interconnect terminal of claim 9, wherein the first positive input terminal is electrically isolated from the second positive input terminal, and the first negative input terminal is electrically isolated from the second negative input terminal with the actuator being in the second position.

12. The loudspeaker interconnect terminal of claim 1, further comprising:
a circuit board with the electrical switch and the first and second sets of input terminals being electrically connected thereto;

13. The loudspeaker interconnect terminal of claim 12, wherein the circuit board further includes crossover circuitry.

14. The loudspeaker interconnect terminal of claim 12, wherein the circuit board further includes overload protection circuitry.

15. The loudspeaker interconnect terminal of claim 1, wherein each of the input terminals is selected from the group consisting of: a universal binding post and a biased lever.
